(19) United States
(12) Patent Application Publication
(10) Pub. No.: US 2009/0016497 A1
(43) Pub. Date: Jan. 15, 2009

(54) NETWORK EDGE TELEPHONY DEVICE WITH AUDIO MESSAGE INSERTION

(75) Inventors: James Nicholas Green, Cambridge (GB); Jonathan Edward Vernon Custance, Cambridge (GB)

Correspondence Address: Levenfeld Pearlstein, LLC;Intellectual Property Department, 2 North LaSalle, Suite 1300, Chicago, IL, 60602, US

(73) Assignee: CAMRIVOX LTD., Cambridge (GB)

(21) Appl. No.: 12/096,880

(22) PCT Filed: Dec. 13, 2006
(86) PCT No.: PCT/GB2006/004665

§ 371 Date: Sep. 10, 2008

(30) Foreign Application Priority Data
Dec. 15, 2005 (GB) 0525560.9

(51) Int. Cl. H04M 1/64

(52) U.S. Cl. 379/88.22

(57) ABSTRACT

A network edge telephony device for local audio message insertion comprises a network interface for receiving data from and transmitting data to a network, and a user interface for receiving data from and transmitting data to a user, the data including data representing an audio signal, and processing means coupled to the network and user interfaces, the processing means comprising a mixer adapted to locally mix a call progress tone derived in dependence on an audio signal received from the network or user interfaces with a data stream representing a pre-recorded audio message. Also provided is user event processing means coupled to the user and network interfaces, which is adapted to detect feedback from the user and generate and transmit an event data signal to a remote server via the network interface.

### FIELD OF THE INVENTION

The present invention relates to network edge telephony devices and to voice-over internet-protocol devices in particular.

### BACKGROUND TO THE INVENTION

It is widely known for telephony devices to provide audio tones and messages to an end user. These vary from a simple ring tone alerting the user to an incoming call, through call status tones (e.g. an engaged tone) to more complex automated menu systems. Similarly, recorded messages may be replayed to the end user. Other types of networked devices having an audio interface can provide similar functionality.

However, in existing systems the tone or messages are generated by part of the network at a point remote from the end-device. US2003223403 describes such a system where the messages are generated in the network and processing of user responses is also performed in the network. The system works by immediately connecting an end-point to the network as soon as it is taken off-hook and presenting the user with audio messages, allowing them to respond as appropriate.

Although such systems are widespread, they are somewhat inflexible as they operate by centralised generation and insertion of information for audio messages, requiring routing via the network operator. There is therefore a need for a more flexible system by which audio information may be provided to end users and greater control exercised over the content. Such functionality is particularly desirable in the context of the latest generation of telephony devices.

### SUMMARY OF THE INVENTION

According to the present invention, a network edge telephony device for local audio message insertion comprises:

a network interface for receiving data from a network and transmitting data to the network, including data representing an audio signal, the network interface including one or more network ports;

a user interface for receiving data from a user and transmitting data to the user, the data representing an audio signal, the user interface including one or more user ports; and,

processing means coupled to the network interface and to the user interface, wherein the processing means comprises a mixer adapted to mix a call progress tone derived in dependence on an audio signal received from at least one of the network interface and the user interface with a data stream representing a pre-recorded audio message.

Preferably, the processing means comprises:

a first mixer adapted to mix a call progress tone derived in dependence on an audio signal received from the network interface with a data stream representing a pre-recorded audio message; and,

a second mixer adapted to mix a call progress tone derived in dependence on an audio signal received from the user interface with a data stream representing a pre-recorded audio message.

The present invention is directed to network devices that ultimately present an audio interface to the user and have a network interface to connect to other users and servers. Connection of the network edge telephony device to the network is via one or more ports of the network interface and to the end user via one or more ports of the user interface. The invention may be applied to a wide variety of network devices, but is particularly applicable to telephony devices such as Voice-over Internet Protocol (VoIP) phones, VoIP adaptors and mobile phones. The network could include any of the following: a Local Area Network (LAN), a Wide Area Network (WAN), such as the Internet, or a radio network, such as a mobile network.

The invention provides a way of relaying messages to the user at key points in the conversation or communication where a call progress tone is present. The call progress tone may be received from the far-end or may be generated locally. In the latter case, this may be in response to an incoming call from the far end or else initiated by the local user. The message insertion is performed locally on the network edge device for onward transmission to the local user or to the far-end user, whereas previously it has been inserted from within the network. In the context of telephony, a particular advantage of inserting the message on the device at the edge of the network is that the message can be played at any stage in a call, which is simply not possible on existing systems. By generating messages at the end-point and performing processing in the end-point, a much more powerful system is created.

Typically, the device has storage allocated for messages, which can be played to the local user or the far-end user. Preferably, the storage is RAM based and can be volatile or non-volatile. Messages may be received from a remote message server on the network, and stored locally. However, the device may also be adapted for streaming a message in real-time from the remote server, thus reducing or removing the need for a local message store. Messages can be user-specific as the user identity is known by the system, or they can be a general message intended for many users.

The device has the capability of mixing the message with other audio signals, allowing the message to be conveyed at times previously not possible on known systems. For example an advert could be played at the same time as the ringing call progress tone by mixing the two data streams. This is most easily implemented when the device also incorporates a tone generator for local tone generation rather than utilising a tone signal generated remotely in the network. The message can be played to the local user via an audio interface, such as a speaker or earpiece, or the message can be directed to the far-end and played to remote users (for example when they are placed on-hold). Interaction with the far-end also enables features such as Audio Caller-ID, whereby a recorded message asking for identification is relayed to the far end and the audio response is relayed to the local user before the connection is made.

The invention also supports the insertion of “fake” call progress tones to allow more time for the message to be played. For example, after dialling a number, the ringing tone could begin playing before the call is actually made, giving more time for a message to be played.

Preferably, the device further comprises user event processing means coupled to the user interface and the network interface, the user event processing means being adapted to:

detect an input received from the user via the user interface in response to a mixed call progress tone and pre-recorded audio message;

generate an event data signal responsive to the input; and;

transmit the event data signal to a remote server via the network interface.

In this way, the device also provides a mechanism for capturing user feedback, which can be used to respond to a message. The feedback can be speech from the user that the device recognises (speech recognition), or as the result of the user pressing a button, or from Dual Tone Multi-Frequency (DTMF) tones. The feedback can be captured at various times, such as during the ringing tone. By comparison, such information is discarded and lost in known systems.

There are many applications for the feedback feature. One example is where the user registers interest in something that was advertised and requests further information (for example by email). Another example is in indicating that a phone call is a nuisance call and that a block-list should be updated to reflect this information (a local or remote/shared block-list can be supported).

Using the feedback mechanism, or other equivalent mechanism, the device is able to maintain user preferences that affect which messages are played. For example, the user might indicate that adverts of a certain type are of no interest to them, and that the device should adapt to play adverts that are more appropriate.

Finally, the invention allows the user to specify preferences so that message delivery can be tailored based on certain parameters such as time of day, or to update a block-list or the like.

### BRIEF DESCRIPTION OF THE FIGURES

An example of the present invention will now be described in detail with reference to the accompanying drawings, in which:

FIG. 1 illustrates a VoIP telephony system in which the network edge device forms part of a VoIP adapter connected to a telephony device;

FIG. 2 illustrates a VoIP telephony system in which the network edge device forms part of a VoIP telephone; and,

FIG. 3 shows a detailed schematic of a network edge device according the present invention.

### DETAILED DESCRIPTION

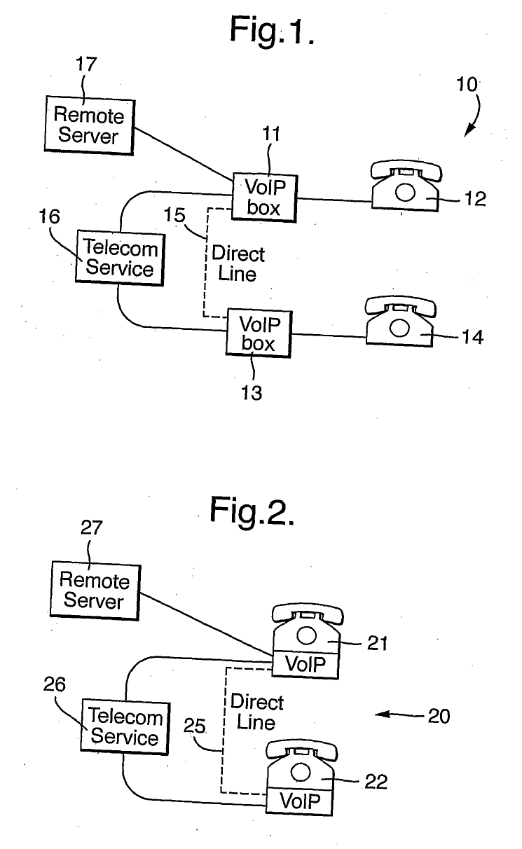

FIG. 1 illustrates the application of the present invention to a VoIP telephony system 10. As shown, two VoIP-enabled telephony units are in communication via one or more networks. Each VoIP-enabled telephony unit comprises a VoIP adapter 11, 13 and a corresponding telephony device 12, 14, the adapter connecting the telephony device to the network. Each VoIP adapter comprises a network edge device according to the present invention. One unit acts as the local user unit 11, 12 and the other as the far-end unit 13, 14. The two devices may connect via a standard telecommunications operator 15 and/or via another network path 16. Each device may also communicate with one or more remote servers 17 via the network.

In this context, each network edge devices provides data paths between the network and the end telephony device, the telephony device providing an audio interface to the user. Importantly, as will be described later, the network edge device also provides the functionality for inserting audio messages locally for onward transmission to either the local user or the far-end user, and also the functionality for detecting user feedback and forwarding this information via the network.

FIG. 2 illustrates a slightly different VoIP telephony system 20 in which the two VoIP-enabled telephony units are dedicated VoIP telephones 21, 22. In this example each VoIP telephone comprises a network edge device according to the present invention. Again, one unit acts as the local user unit 21 and the other as the far-end unit 22.

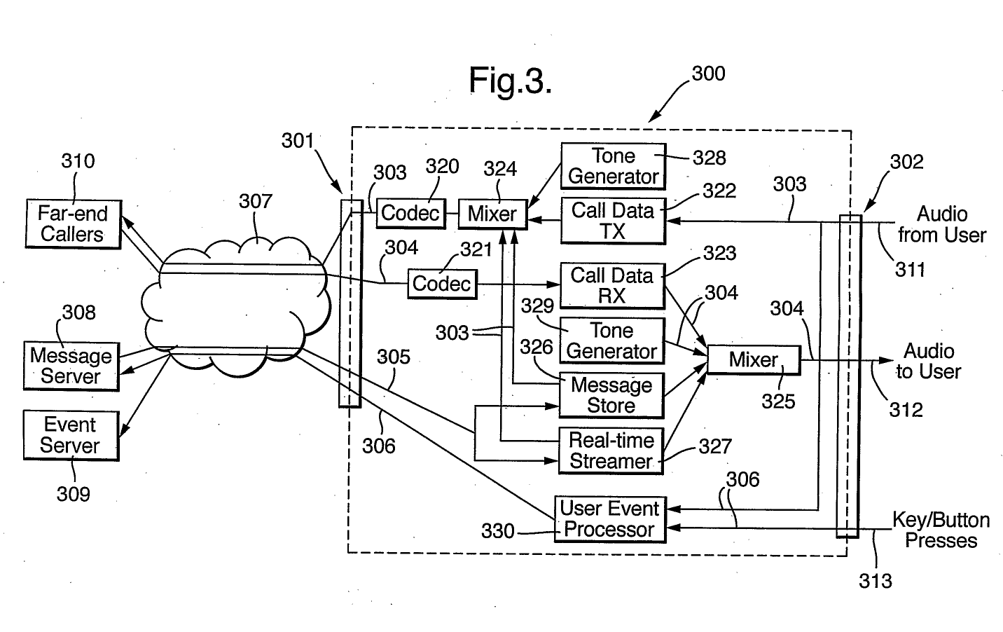

We now consider the network edge device 300 and its internal components in more detail, as illustrated in FIG. 3. Connection to a network is achieved via a network interface 301, which may comprise several ports for physical connection. A user interface 302 is provided for connection to an audio interface by means of which audio signals are relayed to and from a user. Various data paths exist between the ports and within the device. The four main types of data path are those for audio transmission from the local device to the far-end 303, for audio reception by the local device from the far end 304, for audio message transmission 305 and for user feedback 306.

Using the network port, connection to any suitable network 307 is possible, including one or more of a Local Area Network (LAN), a Wide Area Network (WAN), such as the Internet, or a radio network, such as a mobile network. In this way, the device 300 may communicate with a variety of remote devices, including remote servers 308, 309 and one or more far-end users 310.

The user interface 302 may comprise several user ports providing for various physical connections, which will typically include an audio interface and input from other user-activated features. FIG. 3 shows an audio input 311 (from a user microphone or telephone handset, for example), an audio output 312 (to a user speaker or telephone earpiece, for example) and an input from a user-activated key or button 313. In the case of a stand-alone device, such as the adapter 11, 13 shown in FIG. 1, the user input will typically be carried as part of the audio input from the user, in the form of DTMF tones, for example.

Outgoing and incoming telephone calls are coded and decoded, respectively, by means of a coder-decoder (codec) 320,321. Typically, the codec will execute an audio. compression/decompression algorithm. A transmitter unit 322 processes outgoing call data before compression and a receiver unit 323 processes incoming call data after decompression.

A mixer 324, 325 is provided in each of the transmitter and receiver paths for combining audio data such as messages with the incoming or outgoing call data. The mixer 324 for the outgoing data is located between the call data transmitter 322 and its respective codec 320, whereas the mixer for the incoming data is located between the call data receiver 323 and the appropriate user port connection, for example the audio output 312.

Connected to both mixers 324, 325 is a message store 326, which holds audio samples originating from various sources. For example, the message store may be in communication with a remote message server 308 from which updates may be received. The audio samples may also be recordings originating from the far-end user device 310, in which case the audio data received from the far-end can be written to the message store for immediate playback or else to played back later.

In the case of a remote message server, data is transferred across the network using a standard client-server protocol like HTTP, and is written into the message store. The message server can communicate with a plurality of network edge devices allowing data transfer to and from message stores located on many end-points. A mechanism may also exist to allow end-points to uniquely identify themselves to the message server, for example by including a unique identifier in messages sent from an end-point. An example of such a unique identifier would be the media-access control (MAC) address of the end-point. The MAC address is an identifier for distinguishing between different devices on the same network and is typically represented as six hexadecimal numbers (for example 00:20:2B:AB:CD:EF).

The message store 326 will typically comprise volatile or non-volatile random access memory (RAM) for storing the audio data. The audio data will often represent a message and can be stored in raw format, suitable for direct input into a mixer, or else the messages can be stored in a compressed form, which means they must first go through a decompression routine or codec before entering the mixer.

Examples of messages that may be held by the message store include:

Advertisements (specific to the user or more general)

Service warnings (eg. reporting problems with a service, or diagnostics)

Emergency warnings (eg. weather, such as tornadoes)

Audio Caller-ID (described later)

It should be noted that, as the message server may have information about the user identity, messages sent by the server might be user-specific and therefore targeted as such.

The network edge device 300 may also include a real-time streamer 327, which serves a similar function to the message store, except that it requires minimal storage capacity in RAM. The real-time streamer also receives data from the message server, but does not store data to the message store. Instead the real-time streamer passes the data directly to either mixer 324 or mixer 325. This allows playing of messages that are too big to be held in RAM. In principle, the real-time streamer could negate the need for a separate message store, but in practice both mechanisms will be provided.

The mixers 324, 325 are capable of taking multiple audio streams and mixing them so that the user hears all of them. This enables the system to play messages at any time in a communication, although some times make more sense than others. Examples of appropriate time slots include:

During a call: Messages and notifications can be played during a call. For example, in an emergency such as a tornado, or for less severe situations such as paging somebody in an office.

During call progress tones: For example, when hearing ringing and waiting for the far-end to answer the call.

When on-hold: When putting a user on-hold the local system could play a message to the far-end system (like a replacement for on-hold music).

At the end of a call: After the far-end has hung-up, but before the local user does so.

Prior to dial tone, when the phone is first taken off-hook.

Often a call progress tone, particularly a dial tone, is generated remotely somewhere in the network. However, such tones may be replaced or supplemented by tones generated locally, if the network edge device comprises an integral tone generator. The device shown in FIG. 3 has two integral tone generators 328, 329, which are connected to the mixers 324, 325 for the transmitter and receiver paths, respectively. Of course, a single tone generator could be employed to generate tones for both data streams. The provision of local tone generators facilitates the insertion or interleaving of audio messages from the message store or real-time streamer.

Examples of call progress tones that may be generated locally by the device tone generators include:

Dial-tone (the tone heard prior to dialling a number)

Ringing tone: both in response to an incoming-call and after dialling a number

Line engaged

Call-waiting

On-hold music

By interleaving a message with a ringing tone, the user may hear the message in the earpiece at the same time as the ringing tone while waiting for a far-end user to answer a call initiated by the local user, or before answering a call initiated by a far-end user.

As shown in FIG. 3, the device 300 may also comprise a user event processor 330. This sub-system is responsible for processing feedback from the user and can be adapted to recognise a large variety of feedback signals. Moreover, the user event processor 330 may be adapted to generate an appropriate signal or message for communicating to a remote server via the network. The detected feedback can originate in many ways, including:

Speech from the user that the device recognises (speech recognition),

A signal generated by the user pressing a key or button

A dual-tone multi-frequency (DTMF) tone generated as a result of the user pressing a key or button. The DTMF tone may originate either locally or remotely

For a given session or call, feedback can arise at any time, providing a call progress tone is present or else is generated. Examples of possible time slots include:

Before the call: This is where feedback is received during dialling or ringing. During dialling, DTMF tones are used to dial a user's number, but after a full number has been dialled, subsequent numbers are normally discarded. These are the ones that can be used for feedback. Other types of feedback can be interpreted immediately as they are unambiguous.

During the call: Feedback can be received during a call, for example to convey that the call is a nuisance call and a block-list should be updated.

After the call: This is where feedback is received after a call has ended, but before the hand-set is replaced.

Once feedback has been received, the system can take action as appropriate. For example, if the feedback is registering interest in an advertised product, the device could notify the vendor's server 309 on the Internet. If the call was a nuisance call, the feedback could be used to update an on-line block-list.

The network edge telephony device according to the present invention enables a large array of features, which existing systems are unable to implement. Several of these are described in detail below.

As the message store is capable of storing messages received from the far-end, this can be used to enable an audio caller identification (ID) mechanism, which operates as follows.

1) An incoming call is originated by a far-end user 310 to the local user.

2) The call is automatically answered by the local device and a pre-recorded message (from the message store 326) is played to the far-end user via mixer 324. The local receiving end does not ring at this time, but remains as though no call was present.

3) The recorded message being played to the far-end user 310 asks them to identify who they are and the verbal response is recorded to the message store 326. The data path for this recording is from the call data receiver 323 to the message store 326.

4) The receiving end now begins ringing, but the ringing is mixed with the recorded message identifying the far-end.

5) The local user connected to the device hears both ringing and the message identifying the caller and can decide whether or not to answer the call.

The method described above requires the actual “ringer” on the phone to be capable of playing arbitrary audio samples, and not just a simple ringing tone. If this is not possible, because of the nature of the ringer hardware, then the following steps may occur:

1-3) These steps are as steps 1) to 3) above.

4) The receiving end now begins ringing as normal and, because the ringer is not capable of playing arbitrary audio samples, no Audio Caller-ID is heard at this stage.

5) The receiving user takes the phone off-hook to answer the call, but initially the call is not connected.

6) Before connecting the call, the local device plays the Audio Caller-ID message through the earpiece to the local user connected to the device. The data path is from the message store 326 via mixer 325 to the user.

7) On hearing the caller identify the user can decide whether to hang-up and not take the call, or wait and the call will be connected as normal.

The device also supports the maintenance of trusted caller list who need not identify themselves. This means that regular callers need not be hindered by always having to identify themselves. In this situation callers are identified to the receiving user by the regular caller-ID mechanism, such as that incorporated into VoIP protocols, or PSTN networks.

Another feature enabled by the device is advertising, as the message store 326 can be used to hold audio adverts. As previously discussed, the remote message server 308 can differentiate individual users, and therefore the adverts can be tailored to be of most relevance to the particular end user. A device adapted to enable this feature might operate as follows:

1) A user wishes to make an outgoing call and takes the phone off-hook and prepares to dial a number.

2) The tone generator 329 plays a dial tone to mixer 325, indicating to the user that they may begin to dial.

3) When the user commences dialing, tone generator 329 stops playing a dial-tone.

4) The user completes dialing the required number. Normally at this point the user would hear ringing (from tone generator 329) as the system waits for the far-end to pick-up and answer the call. However, the device can use mixer 325 to both generate a ringing tone to the user, and an audio advert.

5) Once the far-end user answers the call, both the ringing and advert stop, and the normal RX/TX data paths 304, 303 are enabled to allow the call to progress as normal.

Sometimes the duration of ringing is not long enough to hear a full advert, especially if the call recipient answers quickly (step (4) above is very short in duration). In this scenario, it is possible for the device to delay connecting the call, to allow it more time to play the advert. At the beginning of step (4) ‘fake’ call progress tones can be inserted and mixed with the advert to give the user the illusion that the call is in progress, while extending the time available to play the advert. Of course, the above example could equally well apply to another form of call progress tone such as a busy or engaged tone, rather than the simple ringing tone.

The advertising facility described above can be extended still further, if feedback is collected from the user, which relates to his or her response to the advert. When an outgoing call is made as above, dialed numbers are discarded between the user completing dialing and the call being connected. That is to say, dialed numbers are discarded while the user hears ringing. However, the device does not discard these numbers, but instead passes them to the user event processor 330 shown in FIG. 3.

The user event processor can take arbitrary action with the feedback it receives. For example, during an advert being played to the user as described above, the user may be told to press 1 on their phone to register interest in the advertised product and be sent more information about the product. The user event processor 330 can inform a remote event server 309 (see FIG. 1) of the user feedback using a standard mechanism such as HTTP. The notification will typically include the unique identifier of the end-point user.

It should be noted that the example of pressing 1 above to register interest could equally well be achieved by the user speaking their response and the user event processor recognizing the input, or indeed any other form of input available to the device.

Another facility enabled by the user event processor 330 is the ability to indicate that a received call is a nuisance call (or SPAM). A certain event, such as pressing the # button on the phone could be used to indicate that the current call is SPAM. The user could press this button during Audio Caller-ID, in the middle of a call, or even at the end of a call after the far-end has hung-up, but before the user has done so.

Upon receipt of SPAM notification the user event processor can take whatever action it has been programmed to take. This might include updating a block-list with information about the caller, including the Caller-ID or other information such as IP address or session initiation protocol (SIP) uniform resource identifier (URI), to prevent further calls from this user. The block-list could even be a shared list on an external server so that many users can immediately receive protection from the same spammer.

As indicated previously, a wide range of messages may be played to a user at varying times during a call. In particular, it is possible for a remote message server 308 to request the message store 326 to play a message immediately, thereby interrupting the call. An example situation would be in the event of an emergency such as a tornado warning. In this situation, the message store 326 would send its message to mixer 325 to be mixed with some form of interrupt call progress tone to be sent to the user, and possibly the far end. Depending on the hardware make-up of the device the audio could be played on a speaker or via an earpiece of the device.

During a call, particularly during an interruption, it is possible for the far-end to be put on hold. In this situation the message store can relay a message (such as an advert) to the far-end user through mixer 324.

As described above, a network edge device according to the present invention has particular application in VoIP telephony, enabling a wide range of functionality that is not possible with existing systems. However, the technology could also be employed in other types of telephony devices such as mobile phones, where there is potential for localised message and advert insertion. Moreover, the technology could extend to any other network edge telephony device that employs call progress tones.

1-17. (canceled)

18. A network edge telephony device for local audio message insertion comprising:
a network interface for receiving data from a network and transmitting data to the network, including data representing an audio signal, the network interface including one or more network ports;
a user interface for receiving data from a user and transmitting data to the user, the data representing an audio signal, the user interface including one or more user ports; and,
processing means coupled to the network interface and to the user interface, wherein the processing means comprises a mixer adapted to mix a call progress tone derived in dependence on an audio signal received from at least one of the network interface and the user interface with a data stream representing a pre-recorded audio message.

19. The device according to claim 18, wherein the processing means comprises:
a first mixer adapted to mix a call progress tone derived in dependence on an audio signal received from the network interface with a data stream representing a pre-recorded audio message; and,
a second mixer adapted to mix a call progress tone derived in dependence on an audio signal received from the user interface with a data stream representing a pre-recorded audio message.

20. The device according to claim 18, wherein the processing means is adapted to enable and disable a data path between the network interface and the user interface.

21. The device according to claim 18, wherein a call progress tone to be mixed with a pre-recorded audio message is part of the audio signal received by the network interface.

22. The device according to claim 18, wherein the device further comprises a tone generator coupled to the processing means and adapted to generate a call progress tone in dependence on the audio signal received from at least one of the network interface and the user interface, wherein the generated call progress tone is to be mixed with the data stream representing the pre-recorded audio message.

23. The device according to claim 18, wherein the device further comprises data storage means coupled to the processing means, the data storage means adapted to store data representing a pre-recorded audio message for mixing with the call progress tone.

24. The device according to claim 23, wherein the pre-recorded message is received from a remote server via the network port.

25. The device according to claim 23, wherein the pre-recorded message is received via the network port as part of an audio message.

26. The device according to claim 23, wherein the data storage means comprises a volatile or non-volatile random access memory (RAM).

27. The device according to claim 18, wherein the mixer is adapted to mix a call progress tone with a real-time data stream representing a pre-recorded audio message received from a remote server via the network port.

28. The device according to claim 18, wherein the device further comprises user event processing means coupled to the user interface and the network interface, the user event processing means being adapted to:
detect an input received from the user via the user interface in response to a mixed call progress tone and pre-recorded audio message;
generate an event data signal responsive to the input; and;
transmit the event data signal to a remote server via the network interface.

29. The device according to claim 28, wherein the user event processing means is adapted for speech recognition.

30. The device according to claim 18, wherein the device is configurable by a user to specify message replay preferences.

31. A telephony device comprising an audio interface and a network edge telephony device according to claim 18, the audio interface coupled to the user interface of the network edge telephony device.

32. The telephony device according to claim 31, wherein the telephony device is a voice-over internet-protocol (VoIP) telephone.

33. The telephony device according to claim 31, wherein the telephony device is a mobile telephone.

34. A voice-over internet-protocol (VoIP) telephone adapter comprising a network edge telephony device according to claim 18, wherein the user interface of the network edge telephony device is configured for connection to a user telephony device via one or more of the user ports.
